(19) United States
(12) Patent Application Publication
(10) Pub. No.: US 2012/0325822 A1
(43) Pub. Date: Dec. 27, 2012

(54) FUEL RESERVOIR FOR A MOTOR VEHICLE

(75) Inventor: Günther POZGAINER, Graz (AT)

(73) Assignee: MAGNA Steyr Fuel Systems GesmbH, Sinabelkirchen (AT)

(21) Appl. No.: 13/462,961

(22) Filed: May 3, 2012

(30) Foreign Application Priority Data
Jun. 24, 2011 (DE) 10 2011 105 780.7
Apr. 12, 2012 (EP) 12163976.9

(51) Int. Cl. B60K 15/03

(52) U.S. Cl. 220/562

(57) ABSTRACT

A fuel reservoir for a motor vehicle, including a shell body that is provided with inlet and discharge openings and is manufactured in a synthetic material. The shell body has a storage chamber which receives fuel, and a reinforcement which receives stress forces acting on the shell body is provided inside the storage chamber.

### CROSS-REFERENCE TO RELATED APPLICATIONS

The present application claims priority under 35 U.S.C. §119 to German Patent Application No. 10 2011 105 780.7 (filed on Jun. 24, 2011) and European Patent Application No. 12163976.9 (filed on Apr. 12, 2012), which are each hereby incorporated by reference in their respective entireties.

### FIELD OF THE INVENTION

The present invention relates to a fuel reservoir for a motor vehicle.

### BACKGROUND OF THE INVENTION

When using a fuel reservoir (tank) of this type in hybrid vehicles, an overpressure or an underpressure can occur inside the tank owing to the particular operating conditions of these vehicles. These tanks, therefore, need to be able to permanently withstand an internal pressure that is either higher or lower than the ambient pressure and they also need to be sufficiently durable. Hitherto, only tanks manufactured in metal were able to satisfy these requirements. Metal tanks, however, have the disadvantage of being heavy, thereby increasing the overall weight of the motor vehicle.

U.S. Pat. No. 6,338,420 discloses a tank that includes two synthetic material shells whose shell bodies are reinforced inside by a column against distorting as a result of overpressure or underpressure. In addition, the column is embodied in such a manner that it includes an elastic compensating element or two parts that are frictionally displaceable with respect to each other. However, this known design does not provide sufficient permanent transmission of tension forces or compression forces.

### SUMMARY OF THE INVENTION

it is the object of the present invention to develop a fuel reservoir for a motor vehicle in such a manner that the fuel reservoir permanently withstands a high internal pressure, in particular underpressure and/or overpressure, and is lightweight.

The present invention achieves this object by virtue of a fuel reservoir for a motor vehicle that includes a shell body that is provided with inlet and discharge openings and is manufactured in a synthetic material. The fuel reservoir has a storage chamber configured to receive fuel, and a reinforcement in the storage chamber configured to compensate forces acting on the shell body. The reinforcement includes a reinforcement support and a stress relief device. The reinforcement support has a receiving chamber that is embodied inside the reinforcement support and is provided for the stress relief device. The stress relief device is arranged at least partially in the receiving chamber of the support and penetrates the shell body.

As a result of the embodiment in accordance with the invention whereby a substantially rigid reinforcement is provided inside the storage chamber for compensating forces acting on the shell body, which includes in particular a stress relief device that penetrates the shell body in certain areas, the fuel reservoir that is manufactured in a synthetic material can permanently withstand the forces that continuously occur under the environmental conditions.

Further embodiments of the invention are described in the subordinate claims, description and the attached drawings.

Preferably, the reinforcement support is a synthetic material support, i.e., is composed of synthetic material. Preferably the reinforcement support has an elongated shape or cross-section. It is particularly preferred that the reinforcement support is embodied in the shape of a straight column and/or includes plane-parallel end surfaces. Alternatively or additionally, the reinforcement support may have an open longitudinal rib structure, thus providing a good support against compression forces, such a structure including a plurality of first reinforcement support sections extending along the longitudinal axis of the reinforcement support and a plurality of second reinforcement support sections extending circumferentially and which intersects the first reinforcement support sections.

Preferably, both ends of the stress relief device penetrate the shell body. As a consequence of this, it is possible that the tension forces on both sides of the stress relief device can also be absorbed elsewhere other than only from the internal chamber of the fuel reservoir. Preferably the support is connected at its end surfaces to the shell body by material engagement and in particular is welded thereto.

In accordance with embodiments, a fuel reservoir for a motor vehicle is provided, the fuel reservoir including at least one of the following: a shell body having an inlet opening and a discharge opening, the shell body being composed of a synthetic material; a storage chamber defined by the shell body and configured to receive fuel; and a reinforcement extending through the storage chamber and configured to receive mechanical forces which act on the shell body, the reinforcement having a reinforcement support and a stress relief device, the reinforcement support having a receiving chamber extending therethrough and configured to receive the stress relief device, and the stress relief device extending through the receiving chamber and the shell body.

In accordance with embodiments, a fuel reservoir for a motor vehicle is provided, the fuel reservoir including at least one of the following: a shell body having an inlet opening and a discharge opening, the shell body being composed of a synthetic material; a storage chamber defined by the shell body and configured to receive fuel; a plurality of reinforcements extending through the storage chamber and configured to receive mechanical forces which act on the shell body, each reinforcement having a reinforcement support and a stress relief device which engages the outer surface of the shell body, the reinforcement support having a receiving chamber extending therethrough and configured to receive the stress relief device, and the stress relief device extending through the receiving chamber and the shell body; a sealing element that seals the receiving chamber from the storage chamber; and a cap which seals the head from the environment, the cap being attached to the shell body.

It is particularly preferred that the connection by material engagement separates the receiving chamber that is embodied inside the reinforcement support and provided for a stress relief device from the storage chamber in a sealing manner. As a consequence, the receiving chamber for the stress relief device is separated from the fuel in the storage chamber. Preferably a sealing element, in particular a sealing ring, separates the receiving chamber that is embodied inside the support and is provided for a stress relief device from the storage chamber in a sealing manner. The sealing element ensures in particular in addition to the support being welded in a sealing manner that the receiving chamber and the storage chamber are separated reliably in a fluid-tight manner.

Preferably, the stress relief device is a tension pin that extends preferably at least partially in a longitudinal bore that is embodied as a receiving chamber inside the support. It is particularly preferred that the tension pin is embodied as a stud bolt or a riveting bolt, whose head acts against a section of the outer surface of the shell body. It is particularly preferred that heads at both ends of the tension pin act against the outer surfaces of the shell body. As a consequence, it is guaranteed that tension forces are absorbed in a particularly reliable manner.

Preferably, the head of the stress relief device is embodied by a screw nut or a screw nut together with a washer.

Preferably, the head of the tension pin is separated in a sealing manner from the environment by a cover cap which is attached to the shell body by material engagement and preferably is welded thereto. By virtue of the cover cap, it is possible to reduce the fuel emission, in particular the hydrocarbon emission, in the region of the connection sites of the reinforcement elements in the region of the shell body.

It is particularly preferred that the fuel reservoir includes a plurality of reinforcements that are preferably arranged almost in parallel with each other. As a consequence, the fuel reservoir is supported in accordance with the invention at a plurality of sites.

### BRIEF DESCRIPTION OF THE DRAWINGS

The invention is described below by means of exemplary embodiments illustrated in the drawings in which show:

FIG. 1 illustrates a perspective schematic view of a fuel reservoir for a motor vehicle in accordance with the present invention.

FIG. 2 illustrates a perspective view of a support as individual parts embodied in different lengths.

FIG. 3 illustrates a sectional view through a reinforcement arranged inside the storage chamber with a stress relief device, which penetrates the shell body, and a support.

### DETAILED DESCRIPTION OF EMBODIMENTS

The fuel reservoir 1 illustrated in a schematic perspective view in FIG. 1 and referred to hereinunder in short as tank includes a shell body which is composed of a synthetic material, and a plurality of reinforcements 5 configured to receive or otherwise compensate forces that act on the shell body 3. The shell body 3 is preferably formed from a first shell 3a and a second shell 3b, which are mutually connected via a circumferential flange, preferably welded thereto or connected by material engagement.

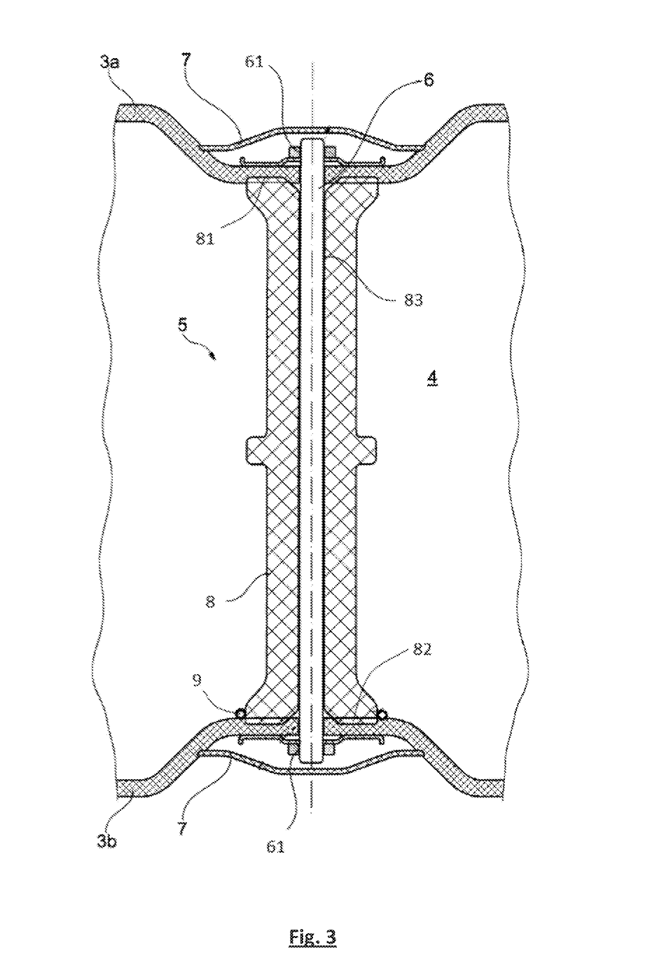

As illustrated in FIG. 3, the reinforcements 5 are arranged inside the storage chamber 4 of the fuel reservoir 1. Each reinforcement 5 includes elongated supports 8 which are composed of a synthetic material, and a stress relief device 6 that penetrate the shell body 3 in certain areas and which transmits the tension forces. The stress relief device 6 have, among other things, a role of preventing the shell body 3 from distorting and/or collapsing as a result of internal pressure. The supports 8 are embodied as column-shaped elements that are arranged in parallel with each other. The supports 8 include a cylindrical, elongated shape and have on end regions 81, 82 thereof preferably plane-parallel end surfaces. These include a preferably circumferential, radially extending flange. Each support 8 is connected to the shell body 3 via connection end region 81 to first shell portion 3a and end region 82 to second shell portion 3b. Such connection can occur via, material engagement, such as welding. Greater forces can thereby be transmitted via the surface of the end regions 81, 82 and/or via the radially extending circumferential flange.

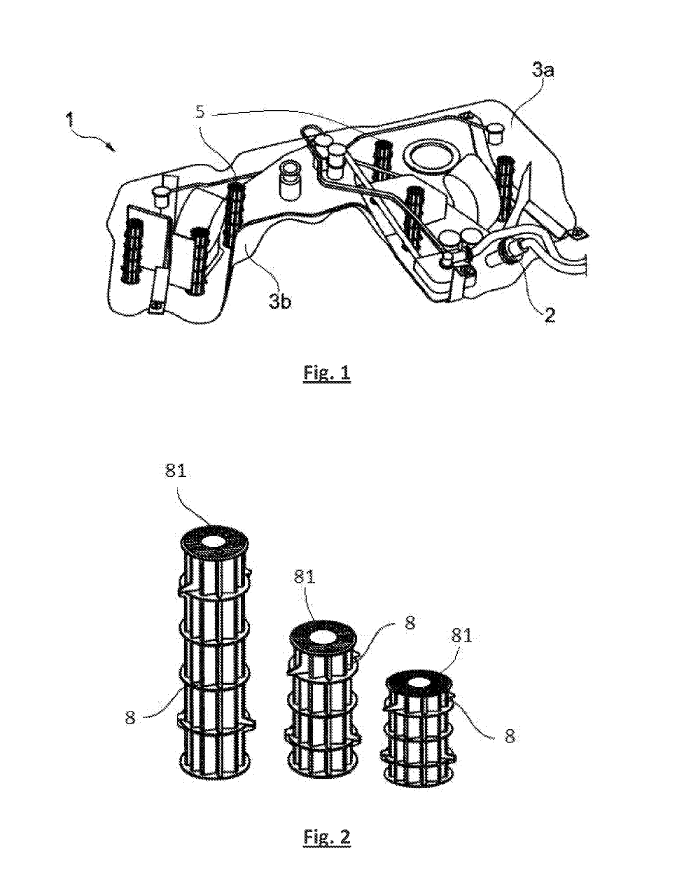

As illustrated in FIG. 2, the column-shaped supports 8 have, for example, an open rib structure. FIG. 2 shows supports 8 in different lengths, which are used accordingly depending upon the spaced disposition of the inner surfaces of opposite regions of the first and second shell. The supports 8 have plane-parallel end surfaces 81, 82. A receiving chamber for a stress relief device is provided in each case inside the supports 8.

As illustrated in FIG. 3, the supports 8 are embodied with a central longitudinal bore that extends in an axial direction. This longitudinal bore is embodied as a receiving chamber 83 for the stress relief device 6 that is embodied as a tension pin and includes heads 61. In the assembled state, this receiving chamber 83 is separated in a fluid-tight manner from the storage chamber 4 by reason of the connection by material engagement of the end regions 81, 82 of the supports 8 with the respective shells 3a, 3b of the shell body 3, and may also be supported by further sealing elements 9 between the support 8 and shell body 3.

The tension pins of the stress relief device 6 are embodied as metal bolts and are used to relieve the stress on the supports 8 that are arranged in the storage chamber 4 and embodied in a synthetic material. This stress relief is necessary as the synthetic material parts and/or connection sites of the synthetic material parts (weld connection synthetic material support/synthetic material shells) experience mechanical creep when exposed to the influences of temperature and fuel and also in the event of any permanent loading occurring. Furthermore, the synthetic material has the capacity to structurally or otherwise mechanically expand under influence of temperature and fuel. The stress relief device 6 render it possible for the shell body 3, despite these properties, to permanently withstand the forces constantly occurring under the environmental conditions described. The tension pins 6 are inserted into the longitudinal bore of the support 8 and are embodied as rod-shaped stud bolts or riveting bolts. The end regions of the tension pins are guided through corresponding through-going bores in the upper or lower shell 3a, 3b respectively of the shell body 3 and are embodied in such a manner that their heads 61 act against a section of the outer surface of the shell body 3. The end regions or heads 61 can take the form of a washer, a nut, a flanged rivet etc.

FIG. 3 further illustrates the heads 61 of the tension pins 6 are separated from the environment in a sealing manner by a cover cap 7 that is attached by material engagement to the shell body 3, and is preferably welded thereto. By arranging the cover cap 7 in this manner, it is possible to reduce the fuel emission, in particular the hydrocarbon emission, in the region of the connection sites of the reinforcement elements in the region of the shell body 3. The cover cap 7 furthermore has means (not illustrated) on the inner side to secure the screw head or the out against undesired rotation.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A fuel reservoir for a motor vehicle, the fuel reservoir comprising:
a shell body having an inlet opening and a discharge opening, the shell body being composed of a synthetic material;
a storage chamber defined by the shell body and configured to receive fuel; and
a reinforcement extending through the storage chamber and configured to receive mechanical forces which act on the shell body, the reinforcement having a reinforcement support and a stress relief device, the reinforcement support having a receiving chamber extending therethrough and configured to receive the stress relief device, and the stress relief device extending through the receiving chamber and the shell body.

2. The fuel reservoir of claim 1, wherein the reinforcement support is composed of a synthetic material.

3. The fuel reservoir of claim 1, wherein the reinforcement support has an elongated shape.

4. The fuel reservoir of claim 3, wherein the reinforcement support a column cross-section.

5. The fuel reservoir of claim 4, wherein the reinforcement support includes an upper end surface and a lower end surface that each extending in parallel planes.

6. The fuel reservoir of claim 5, wherein the reinforcement support has an open longitudinal rib structure that includes a plurality of first reinforcement support sections extending along the longitudinal axis of the reinforcement support and a plurality of second reinforcement support sections extending circumferentially and which intersects the first reinforcement support sections.

7. The fuel reservoir of claim 5, wherein the stress relief device at ends thereof respectively engage a section of the outer surface of the shell body.

8. The fuel reservoir of claim 5, wherein the reinforcement support is connected to the shell body at the upper end surface and the lower end surface.

9. The fuel reservoir of claim 8, wherein the reinforcement support is welded to the shell body at the upper end surface and the lower end surface.

10. The fuel reservoir of claim 8, wherein the connection between the reinforcement support and the shell body seals the receiving chamber from the storage chamber.

11. The fuel reservoir of claim 1, wherein both ends of the stress relief device extend out of the surface of the shell body.

12. The fuel reservoir of claim 1, further comprising a sealing element that seals the receiving chamber from the storage chamber.

13. The fuel reservoir of claim 1, wherein the stress relief device engages a section of the outer surface of the shell body.

14. The fuel reservoir of claim 1, wherein the stress relief device comprises a tension pin.

15. The fuel reservoir of claim 14, wherein the tension pin comprises a bolt having a head that engages a section of the outer surface of the shell body.

16. The fuel reservoir of claim 15, wherein the head comprises one of:
a nut; and
the combination of a screw and a washer.

17. The fuel reservoir of claim 15, further comprising a cap which seals the head from the environment, the cap being attached to the shell body.

18. A fuel reservoir for a motor vehicle, the fuel reservoir comprising:
a shell body having an inlet opening and a discharge opening, the shell body being composed of a synthetic material;
a storage chamber defined by the shell body and configured to receive fuel;
a plurality of reinforcements extending through the storage chamber and configured to receive mechanical forces which act on the shell body, each reinforcement having a reinforcement support and a stress relief device which engages the outer surface of the shell body, the reinforcement support having a receiving chamber extending therethrough and configured to receive the stress relief device, and the stress relief device extending through the receiving chamber and the shell body;
a sealing element that seals the receiving chamber from the storage chamber; and
a cap which seals the head from the environment, the cap being attached to the shell body.

19. The fuel reservoir of claim 18, wherein the reinforcement support has a plurality of first reinforcement support sections extending along the longitudinal axis of the reinforcement support and a plurality of second reinforcement support sections extending circumferentially and which intersects the first reinforcement support sections.

20. The fuel reservoir of claim 1, wherein the reinforcements extend parallel with each other.
